(19) United States
(12) Patent Application Publication
(10) Pub. No.: US 2013/0080475 A1
(43) Pub. Date: Mar. 28, 2013

(54) Employee Profiler and Database

(71) Applicant: Jonathon Gillen, Somerville, MA (US)

(72) Inventor: Jonathon Gillen, Somerville, MA (US)

(21) Appl. No.: 13/244,480

(22) Filed: Sep. 25, 2011

(51) Int. Cl. G06F 17/30

(52) U.S. Cl. 707/798; 707/E17.022

(57) ABSTRACT

A system for generating statistics relating to recorded employee behavior, the system including: a first database of tasks performed by employees, the first database being stored on a computer-readable storage medium; a second database of actions taken by the employees while performing the tasks, the second database being stored on a computer-readable storage medium; and a software program, stored on a computer-readable storage medium, configured to extract information from the databases regarding the tasks performed by the employees as well as the actions performed by the employees while carrying out the tasks. The software program then calculates performance statistics relating to success or failure regarding a particular task. The software program furthermore sorts the employees into subgroups based on their status in the company and then calculates performance statistics for the subgroup to compare against individual performance within the subgroup.

### FIELD OF THE INVENTION

The present invention relates to a system and a method for evaluating an employee, and more particularly to an online system that combines scattered performance data of employees into a common database where it can be sorted and analyzed according to a parameter of interest.

### BACKGROUND

Performance of employees in some career fields (e.g. patent examination in the United States) remains an unrefined art, subject to the personal judgment of the particular employee assigned (e.g., Examiners assigned to the applications). For example, throughout the USPTO there are large variations in Examination procedure. There are also variations between different art units, in both allowance rates and procedure—for instance, there exist statistically significant differences between different art units with respect to allowance rates and rates of restriction requirements. Within art units, there are large variations between examiners in terms of procedure and allowance rates, more or less arbitrarily. The result of these variations is that the patent process from the applicant's point of view becomes a random process. There is a need in the art for a system that can shed light on the patent examination process by means of statistical analysis, which can also be used to maximize the probability of success for a given patent application.

### SUMMARY

In various embodiments, the present invention creates a database by recording and compiling human actions; future responses to stimuli based upon the information in the database can then be predicted. A finite set of actions maybe predefined and then subsequently recorded as they occur. Often times, an action is a result of an external stimulus, which should be apparent in context. The database can then be used to predict human responses to actions or stimuli. Additionally, the present invention may group humans within the database according to a parameter. Statistics can then be compiled on each group in the database and their collective behavior analyzed. In this way, fluctuations in behavior of individuals can be averaged over the group of individuals and broader trends can be analyzed. The average group behavior may then be compared with that of other groups, which can facilitate the avoidance of groups whose average behavior is unfavorable.

Accordingly, in one aspect, a system generates statistics relating to recorded employee behavior. The system includes a first database of tasks performed by employees, the first database being stored on a computer-readable storage medium; a second database of actions taken by the employees while performing the tasks, the second database being stored on a computer-readable storage medium; and a software program, stored on a computer-readable storage medium, configured to extract information from the databases regarding the tasks performed by the employees as well as the actions performed by the employees while carrying out the tasks. The software program then calculates performance statistics relating to success or failure regarding a particular task. The software program furthermore sorts the employees into subgroups based on their status in the company and then calculates performance statistics for the subgroup to compare against individual performance within the subgroup.

In various embodiments, the software program in the system is further programmed to generate a bar chart representing the statistics relating to an employee and the subgroup to which the employee belongs.

In one embodiment, the first database contains information extracted from an application data sheet of a patent application and the employees are patent examiners. In another embodiment, the second database contains information extracted from a transaction history of a patent application.

In some embodiments, the performance statistics are an allowance rate, non-final rejections per patented case, final rejections per patented case, non-final rejections per abandoned case, final rejections per abandoned case, appeal rate, allowance rate on appealed cases, restriction rate, average time to dispose of a case, rate of accepting unamended claims, and/or average number of actions per disposal.

In various embodiments, the system includes a third database containing information relating to patent grants from a previous calendar year.

In one embodiment, the software program further includes a patent application classifier, wherein the patent application classifier is one of a decision tree classifier, maximum entropy classifier, or naive bayes classifier.

In another aspect, a method generates statistics relating to employee performance. The method includes collecting data relating to tasks performed by employees and actions taken by employees while performing the tasks, wherein the data collection is performed by a software program stored on a computer-readable storage medium; storing the data in a database, the database being stored in a computer-readable storage medium; and using a computer processor to (i) extract information from the database, (ii) calculate performance statistics relating to success or failure regarding a particular task, (iii) sort employees into subgroups based upon their status within their company, (iv) calculate performance statistics for the subgroup, and (v) compare individual performance with that of the subgroup.

In various embodiments, the method further includes generating a bar chart representing the statistics relating to an employee and the subgroup to which the employee belongs.

In one embodiment, the method includes extracting information from an application data sheet of a patent application. In another embodiment, the method further includes extracting information from a transaction history of a patent application.

In some embodiments, the method further includes calculating performance statistics, wherein the performance statistics are an allowance rate, non-final rejections per patented case, final rejections per patented case, non-final rejections per abandoned case, final rejections per abandoned case, appeal rate, allowance rate on appealed cases, restriction rate, average time to dispose of a case, rate of accepting unamended claims, and/or average number of actions per disposal.

In one embodiment, the method includes collecting data relating to patent grants from a previous calendar year and using the computer processor to implement a patent application classifier, the classifier being one of a decision tree classifier, maximum entropy classifier, or naive bayes classifier.

In another embodiment, the method further includes classifying a patent application into a particular art unit with a probability greater than ninety percent.

In still another embodiment, the method further includes altering a text of a patent application prior to filing, the alterations being based allowance rates in art units where the patent application is likely to be classified, the alterations being made such that a likelihood of the patent application being assigned to the art unit with a highest allowance rate is maximized.

### BRIEF DESCRIPTION OF THE DRAWINGS

The invention will be better understood from a reading of the following detailed description, taken in conjunction with the accompanying Figures in the drawings in which:

FIG. 1 illustrates a block diagram of an exemplary computerized system and method for compiling and analyzing scattered date related to employee performance;

FIG. 2 illustrates a tabulated allowance rate, non-final rejections per patented case, final rejections per patented case, appeal rate, allowance rate on appealed cases and cases examined by the Examiner being calculated by software program 130. It further illustrates the same quantities being calculated for the Examiner's particular art unit;

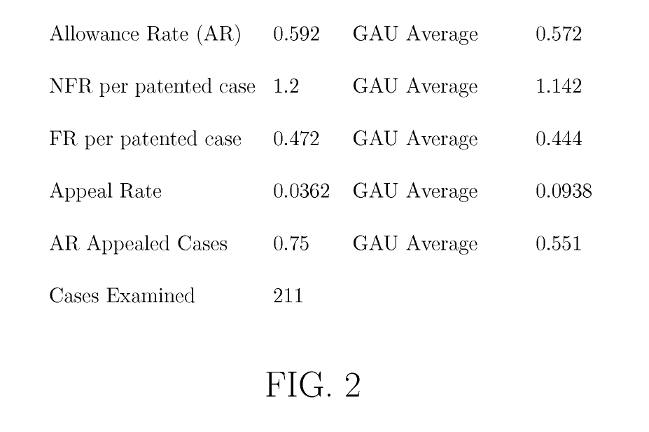

FIG. 3 illustrates a graphical representation of allowance rate, non-final rejections per patented case, final rejections per patented case, appeal rate, allowance rate on appealed cases and cases examined by the Examiner being calculated by software program 130. It further illustrates the same quantities being calculated for the Examiner's particular art unit. Statistical error bars are included;

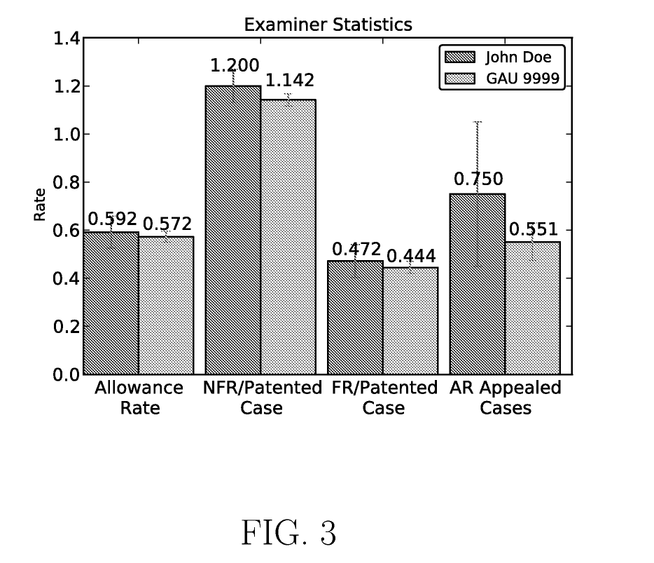

FIG. 4 illustrates a histogram of the number of non-final rejections per patented case and non-final rejections per abandoned case for a particular examiner. The y-axis is a probability density;

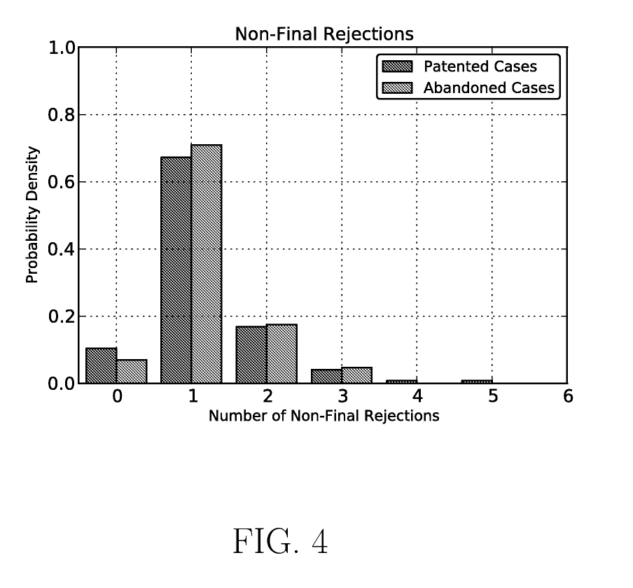

FIG. 5 illustrates a histogram of the number of final rejections per patented case and final rejections per abandoned case for a particular examiner. The y-axis is a probability density;

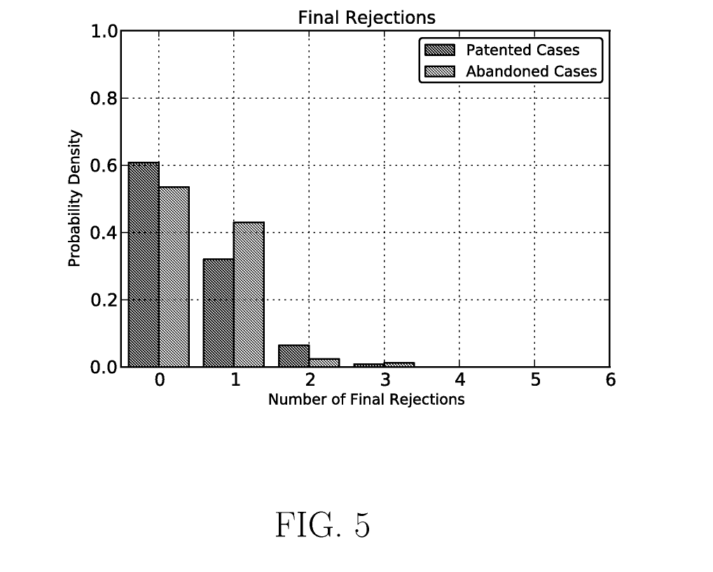

FIG. 6 illustrates a histogram of the number of non-final rejections per patented case and non-final rejections per abandoned case for a particular examiner. The y-axis is the number of occurrences or counts;

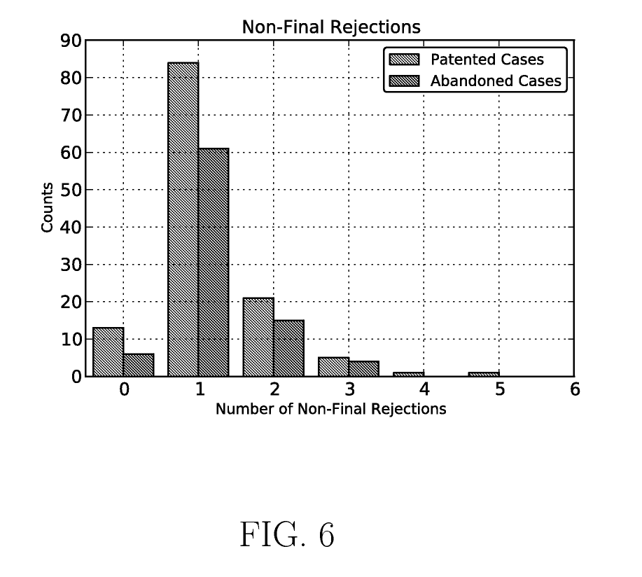

FIG. 7 illustrates a histogram of the number of final rejections per patented case and final rejections per abandoned case for a particular examiner. The y-axis is the number of occurrences or counts.

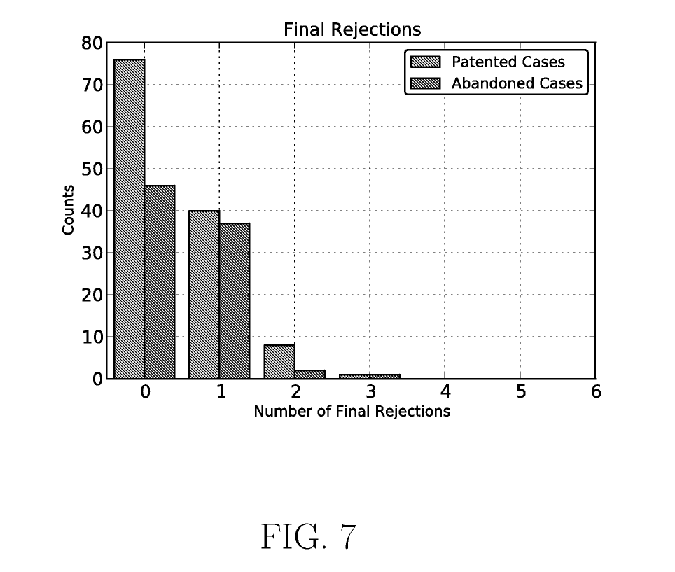

### DETAILED DESCRIPTION

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments can be realized and that logical and mechanical changes can be made without departing from the spirit and scope of the invention. Thus, the detailed description herein is presented for purposes of illustration only and not of limitation. For example, the steps recited in any of the method descriptions can be executed in any order and are not limited to the order presented.

For the sake of brevity, conventional data networking, application development and other functional aspects of the systems (and components of the individual operating components of the systems) cannot be described in detail herein. Furthermore, the connecting lines shown in the various figures contained herein are intended to represent exemplary functional relationships and/or physical couplings between the various elements. It should be noted that many alternative and/or additional functional relationships and/or physical connections can be present in a practical system.

The invention can be described herein in terms of functional block components, screen shots, optional selections and various processing steps. It should be appreciated that such functional blocks can be realized by any number of hardware and/or software components configured to perform the specified functions. For example, the invention can employ various integrated circuit components (e.g., memory elements, processing elements, logic elements, look-up tables, and the like), which can carry out a variety of functions under the control of one and/or more microprocessors and/or other control devices. Similarly, the software elements of the invention can be implemented with any programming and/or scripting language such as C, C++, Java, COBOL, assembler, PERL, Visual Basic, SQL Stored Procedures, extensible markup language (XML), hypertext markup language (HTML), with the various algorithms being implemented with any combination of data structures, objects, processes, routines and/or other programming elements. Further, it should be noted that the invention can employ any number of conventional techniques for data transmission, signaling, data processing, network control, and the like.

The invention is described herein with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions can be loaded onto a general purpose computer, special purpose computer, and/or other programmable data processing apparatus to produce a machine, such that the instructions that execute on the computer and/or other programmable data processing apparatus create means for implementing the functions specified in the flowchart block and/or blocks.

These computer program instructions can also be stored in a computer-readable memory that can direct a computer and/or other programmable data processing apparatus to function in a particular manner, such that the instructions stored in the computer-readable memory produce an article of manufacture including instruction means which implement the function specified in the flowchart block and/or blocks. The computer program instructions can also be loaded onto a computer and/or other programmable data processing apparatus to cause a series of operational steps to be performed on the computer and/or other programmable apparatus to produce a computer-implemented process such that the instructions which execute on the computer and/or other programmable apparatus provide steps for implementing the functions specified in the flowchart block and/or blocks. Accordingly, functional blocks of the block diagrams and flowchart illustrations support combinations of means for performing the specified functions, combinations of steps for performing the specified functions, and program instruction means for performing the specified functions.

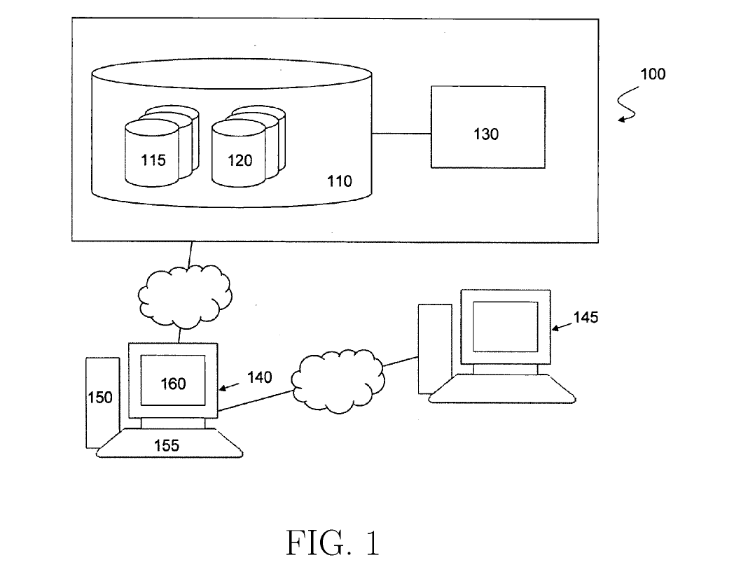

In one embodiment, the invention provides a computerized system and method for collecting and analyzing scattered employee performance data. With respect to FIG. 1, system 100 includes one or more databases 110 comprising information relating to employee performance and previous employee actions. A software program 130 communicates with database 110. Databases 110 and program 130 may operate on one or more host computers 140 and/or remote computers 145.

Host computers 140 and remote computers 145 may comprise one and/or more of the following: a host server 150 and/or other computing systems including a processor for processing digital data; a memory coupled to said processor for storing digital data; an input 155 coupled to the processor for inputting data; an application program stored in said memory and accessible by the processor for directing processing of digital data by the processor; a display device 160 coupled to the processor and/or memory for displaying information derived from digital data processed by the processor; and a plurality of databases. As those skilled in the art will appreciate, host computer 140 may include an operating system (e.g., MVS, Windows NT, 95/98/2000/XP, OS2, UNIX, MVS, TPF, Linux, Solaris, MacOS, AIX, etc.) as well as various conventional support software and drivers typically associated with computers.

Host computer 140 may communicate with databases 110 and/or remote computers 145 through a direct connection and/or network connection. As used herein, the term network can include any electronic communications means which incorporates both hardware and software components of such. Communication among the components and/or parties in accordance with the invention can be accomplished through any suitable communication channels, such as, for example, a telephone network (such as a public switched telephone network or Integrated Services Digital Network (ISDN)), an extranet, an intranet, Internet, point-of interaction device (personal digital assistant, cellular phone, kiosk, etc.), online communications, off-line communications, wireless communications, transponder communications, local area network (LAN), wide area network (WAN), networked and/or linked devices and/or the like. Moreover, the invention can also be implemented using TCP/IP communications protocols, IPX, Appletalk, IP-6, NetBIOS, OSI and/or any number of existing and/or future protocols. If the network is in the nature of a public network, such as the Internet, it can be advantageous to presume the network to be insecure and open to eavesdroppers and, therefore, employ a conventional encryption program. One encryption program that may be used is for example, “Blowfish”. Specific information related to the protocols, standards, and application software utilized in connection with the Internet is generally known to those skilled in the art.

Databases 110 can comprise one or more local, remote or other databases used for information storage and retrieval. Databases 110 can be a graphical, hierarchical, relational, object-oriented or other database. The databases may be configured such that information can be suitably retrieved from the databases and provided to software program 130.

A system for evaluating a patent examiner combines information relating to patent applications directly related to the examiner, such as the transaction history, application data, and image file wrapper into a common database 115. The transaction history for a particular patent application is a recordation of all actions that have occurred with regard to the particular application. The application data contains information such as the Examiner to whom the case is docketed, the case status, the status date, etc. The image file wrapper contains all of the correspondence between the applicant and the patent office.

The present invention allows the applicant to profile and predict examiner behavior after the docketing of the case. In this way, the probability of obtaining an allowance can be maximized throughout the patent prosecution process. The present invention also makes transparent the patent prosecution procedure, by providing quantitative statistics by which to measure examiner performance. Currently, information regarding examiner behavior is largely anecdotal, but the present invention would provide objective data with which examiner performance can be quantified.

In some embodiments of the present invention, a database 115 is compiled of past examiner behavior. The database includes information about patent applications such as case status, class/subclass, art unit, examiner name, filing date, status date, as well as any other information which can help to determine patterns in examiner behavior and/or maximize probability of allowance during patent prosecution. Furthermore, the database contains a list of actions taken by the examiner for each application, such as, but not limited to restriction requirements, non-final rejections, final rejections, and replies to notices of appeal.

With this information in hand, statistics can be computed for each examiner and each art unit by software program 130. In various embodiments, metrics such as non-final rejections per patented case, final rejections per patented case, appeal rates, and allowance rates can be computed. For example, an average number of non-final rejections per patented case for a particular examiner can be calculated by first counting the total number of non-final rejections given on patented cases by the particular examiner and then dividing by the total number of patented cases examined by the particular examiner. The average number of final rejections per case may be calculated in a similar way. The allowance rate for a particular examiner can be calculated by counting the total number of patented cases and then dividing by the total number of non-pending cases (patented cases and abandoned cases). In a similar manner, in some embodiments, the allowance rate on appealed cases for a particular examiner may be calculated. An appeal rate may be calculated for a particular examiner by counting the total number of cases where the applicant filed a notice of appeal and then dividing by the total number of cases related to the particular examiner (patented, abandoned, and pending cases). All of the quantities calculated above for a particular examiner may be calculated in the same way for an entire art unit.

In one embodiment of the present invention, the statistical distribution for a parameter can be computed by software program 130. For instance, a histogram that describes the frequency with which non-final rejections occur for patented cases may be constructed. In this example, the number of non-final rejections is counted for each patented case. The number of non-final rejections is then stored in array. This is done for each patented case and then the histogram can be constructed from the array. In the example described, we calculated the histogram for non-final rejections, but this technique may be used to compute statistics for any particular action taken by an Examiner, such as final rejections, restriction requirements, or even notices of appeal filed by applicant.

In one embodiment, Examiners can then be evaluated relative to their respective art units and the USPTO as a whole. Furthermore, art units may be compared. This is important, because a given application may have a significant probability to be assigned to multiple art units. This is due to the human element in the USPTO classification process. In various embodiments, after identifying favorable art units which are likely destinations for the application, the applicant can then modify the vocabulary to include keywords which increase the likelihood of the application being docketed to the most favorable art unit (the art unit with the highest allowance rate).

Furthermore, with information regarding the actions taken by patent examiners, in some embodiment, the applicant can make informed decisions about the action which will most likely lead to a notice of allowance. For instance, by looking at the allowance rate on appealed cases for a given examiner, the applicant can make a decision as to whether an appeal is likely to succeed. This can be done most simply by comparing the average allowance rate on all cases for the particular examiner against the allowance rate on cases where a notice of appeal was filed. In another embodiment, for example, the number of final rejections per patented case can be used to determine whether to continue the prosecution by filing a request for continued examination (RCE), for instance, or abandon the case. To be concrete, if an examiner has a pattern of allowing cases after a single final rejection, but the current application is on it's 2nd or 3rd final rejection, then it is probably time for a different course of action. On the other hand, if it is early in the prosecution and the examiner averages 1 final rejection per allowed case, it stands to reason that after filing a single RCE, the application will be in good condition for allowance.

In a more general sense, the above examples illustrate how to classify examiner behavior based upon allowed and abandoned applications. By analyzing patterns of examiner behavior, the applicant may craft responses to office actions and develop an overall strategy that maximizes the probability of allowance.

In yet another embodiment of the present invention, a list of all applications belonging to a particular examiner is compiled in database 115. The image file wrapper for each application is carefully reviewed and by analyzing which types of arguments lead to patented cases, the applicant can craft an argument that is most likely to succeed with a particular examiner. For instance, some examiners require amendments more often than not, while some examiners are more willing to accept unamended claims and a convincing argument by the applicant. With such information in hand, applicant may craft an appropriate response that will expedite the prosecution and on average lead to a quicker allowance.

In another embodiment of the invention, a database 115 is compiled with respect to the different art units at the USPTO. This database may be used to compute allowance rates for each GAU as well as other useful metrics. Furthermore, in the present embodiment, a database 120 of recent patent grants is compiled and sorted by art unit. In this way, a patent classifier can be constructed which predicts the most probable art unit to which a new application for patent will be assigned. Furthermore, it calculates the probability of assignment to any given art unit. Armed with a list of most probable art units together with the allowance rates for each art unit, an application can be modified such that it becomes likely for it to be docketed to the art unit with the highest allowance rate.

In a preferred embodiment, the patent classifier, implemented by software program 130 is based upon analyzing the most frequently occurring words in patents granted by a given art unit. An amalgamation of these word lists is used to create a master word list. It is important to note that words which are common to all art units are removed from the master word list. Each full text patent grant from the most recent calendar year is then labeled with an art unit and a list is compiled that indicates which words from the master list occur in the given full text patent grant. In this way, a classifier may be trained on a set of recent full text patent grants. The classifier can then be used to predict the most likely art units where an application is to be sent. While a preferred embodiment of the classifier has been described, the classifier may be any one of a decision tree classifier, maximum entropy classifier, naive Bayes classifier, or any other classifier.

In one embodiment, after inspecting the list of likely art units as determined by the classifier, if there is a large difference in allowance rates between likely art units, the classifier can then indicate which addition or subtraction of words would make the application more likely to end up in the art unit with the highest probability of allowance. This can be done without changing the substance of the invention and without adding new matter.

As will be appreciated by one of ordinary skill in the art, the invention can be embodied as a method, a data processing system, a device for data processing, and/or a computer program product. Accordingly, the invention can take the form of an entirely software embodiment, an entirely hardware embodiment, and/or an embodiment combining aspects of both software and hardware. Furthermore, the invention can take the form of a computer program product on a computer-readable storage medium having computer-readable program code means embodied in the storage medium. Any suitable computer-readable storage medium can be utilized, including hard disks, CD-ROM, optical storage devices, magnetic storage devices, and/or the like.

The invention has been described above with reference to various exemplary embodiments. However, those skilled in the art will recognize that changes in modifications may be made to the exemplary embodiments without departing from the scope of the invention. As used herein, the terms “comprises,” “comprising,” and/or any other variation thereof, are intended to cover a non-exclusive inclusion, such that a process, method, article, and/or apparatus that comprises a list of elements does not include only those elements but may include other elements not expressly listed and/or inherent to such process, method, article, and/or apparatus. Further, no element described herein is required for the practice of the invention unless expressly described as “essential” and/or “critical”.

What is claimed is:

1. A system for generating statistics relating to recorded patent examiner behavior, the system comprising:
a memory storing a first database of tasks performed by the patent examiners and
a second database of actions taken by the patent examiners while performing the tasks; and
a computer processor configured to process a software program configured to extract information from the databases regarding the tasks performed by the patent examiners as well as the actions performed by the patent examiners while carrying out the tasks, wherein the software program then calculates performance statistics relating to the outcome regarding a particular task, and wherein the software program is further equipped to sort the patent examiners into an art unit based on information contained in the first database and then calculates performance statistics for the art unit to compare against individual patent examiners within the art unit, and further wherein, the software program is further equipped to alter a text of a patent application prior to filing, the alterations being based allowance rates in art units where the patent application is likely to be classified, the alterations being made such that a likelihood of the patent application being assigned to the art unit with a highest allowance rate is maximized.

2. The system of claim 1, wherein the software program is further programmed to generate a bar chart representing the statistics relating to an employee and the subgroup to which the employee belongs.

3. The system of claim 1, wherein the first database contains information extracted from an application data sheet of a patent application.

4. The system of claim 1, wherein the second database contains information extracted from a transaction history of a patent application.

5. The system of claim 1, wherein the performance statistics are at least one of an allowance rate, non-final rejections per patented case, final rejections per patented case, non-final rejections per abandoned case, final rejections per abandoned case, appeal rate, allowance rate on appealed cases, restriction rate, average time to dispose of a case, rate of accepting unamended claims, or average number of actions per disposal.

6. The system of claim 1, wherein the system further comprises a third database containing information relating to patent grants from a previous calendar year.

7. The system of claim 1, wherein the software program further comprises a patent application classifier, wherein the patent application classifier is one of a decision tree classifier, maximum entropy classifier, or naive bayes classifier.

8. A method for generating statistics relating to patent examiner performance, the method comprising:
collecting data, using a computer processor, relating to tasks performed by patent examiners and actions taken by examiners while performing the tasks;
storing the data in a database in a memory; and
using the computer processor:
(i) extracting information from the database;
(ii) calculating performance statistics relating to success or failure regarding a particular task;
(iii) sorting patent examiners into subgroups based upon their status within their company;
(iv) calculating performance statistics for the subgroup;
(v) comparing individual performance with that of the subgroup; and
(vi) altering a text of a patent application prior to filing, the alterations being based on allowance rates in art units where the patent application is likely to be classified, the alterations being made such that a likelihood of the patent application being assigned to the art unit with a highest allowance rate is maximized.

9. The method of claim 8, the method further comprising generating a bar chart representing the statistics relating to a patent examiner and the art unit to which the patent examiner belongs.

10. The method of claim 8, the method further comprising extracting information from an application data sheet of a patent application.

11. The method of claim 8, the method further comprising extracting information from a transaction history of a patent application.

12. The method of claim 8, the method further comprising calculating performance statistics, wherein the performance statistics are at least one of an allowance rate, non-final rejections per patented case, final rejections per patented case, non-final rejections per abandoned case, final rejections per abandoned case, appeal rate, allowance rate on appealed cases, restriction rate, average time to dispose of a case, rate of accepting unamended claims, or average number of actions per disposal.

13. The method of claim 8, the method further comprising collecting data relating to patent grants from a previous calendar year and using the computer processor to implement a patent application classifier, the classifier being one of a decision tree classifier, maximum entropy classifier, or naive bayes classifier.

14. The method of claim 8, the method further comprising using the computer processor, classifying a patent application into a particular art unit with a probability greater than ninety percent.

15. (canceled)
